(19) United States
(12) Patent Application Publication
(10) Pub. No.: US 2005/0051651 A1
(43) Pub. Date: Mar. 10, 2005

(54) Agitating mill

(76) Inventors: Udo Enderle, Marktredwitz (DE); Jochen Suk, Schonwald (DE)

Correspondence Address: DAFFER MCDANEIL LLP, P.O. BOX 684908, AUSTIN, TX, 78768, US

(21) Appl. No.: 10/969,268

(22) Filed: Oct. 20, 2004

(30) Foreign Application Priority Data
Apr. 30, 2002 (DE) 10219482.3
Apr. 30, 2003 (WO) PCT/DE03/01369

(51) Int. Cl. B02C 18/16

(52) U.S. Cl. 241/172

(57) ABSTRACT

The invention relates to an agitating mill, in which the agitating shaft is provided with several disc-type milling elements. In previous models the milling discs were replaced by being removed disc by disc from the shaft, together with any spacers that were arranged in between and new discs were then mounted. According to the invention, the milling elements consist of several disc segments, which permits the replacement of individual milling elements without having to dismantle additional milling elements on the shaft.

### PRIORITY APPLICATION

The present application claims priority to German application no. 10219482.3 filed Apr. 30, 2002 and PCT application no. PCT/DE03/01369 filed Apr. 30, 2003, published in the German language on Nov. 13, 2003 as WO 03/092897.

### BACKGROUND OF THE INVENTION

1. Field of the Invention

The present invention relates to an agitating mill having a milling container and an agitating shaft rotating therein, on which multiple disk-shaped milling elements are positioned in a row.

2. Description of the Related Art

An agitating mill, in which an agitating shaft is positioned in the milling chamber, is known from U.S. Pat. No. 4,513,917. The agitating shaft carries multiple disk-shaped milling elements spaced axially apart from one another. Each of the milling elements is radially delimited by an edge bead. Between this edge bead and a hub, which is connected to the agitating shaft by a pin connection, the milling element has circular openings. The milling element itself is connected via an internal thread in the agitating shaft region to an external thread on the hub. In order that the milling element may be connected permanently to the hub, the hub is provided with a thread having a reduced hub external diameter over only a part of its surface pointing toward the milling chamber. If the milling element is screwed onto this thread of the hub, the milling element strikes against the hub part having a larger diameter and is clamped thereto. If one or more elements besides the last on the agitating shaft wear down, which occurs unavoidably after a specific number of operating hours, the milling elements positioned in front of them must always also be removed from the agitating shaft for the replacement.

### SUMMARY OF THE INVENTION

The object of the present invention is to design the milling elements in such a way that replacement of single milling elements is made possible. The object is achieved by the features of the present claims.

The achievement of the object according to the present invention is to assemble a disk-shaped milling element from multiple disk segments. In this way, the possibility arises of replacing them individually in the event of wear and/or breakage of milling disks, without the removal of the agitating shaft and/or taking off all or multiple milling elements always being necessary. Particularly for large agitating mills having a large diameter of the milling elements, this saves a large amount of assembly time. For example, using this ability, milling elements from wear-intensive milling zones may also be exchanged after a specific number of operating hours with milling elements from low-wear milling zones. For the assembly and/or dismantling of milling elements having up to 2 m cross-section or more, the weight of the milling elements also plays an essential role. If the milling elements are made of multiple disk segments, this naturally also reduces the technical complexity during the replacement procedure.

According to a refinement of the present invention, the milling elements may also be provided with a single or multipart hub. The advantage in the use of a hub separable from the disk segments is that the hub may be manufactured from a different material and may thus be designed for different load criteria.

On the basis of a further refinement according to the present invention, the disk segments are connected via screw connections to the one-piece or multipart hub, the screw connections reaching in the radial direction from the openings in the segments out into the hub.

Since, according to a further refinement according to the present invention, the partition line of the hub is offset by 15-90° to the partition line of the disk segments, the milling element may be manufactured from only 4 hub and disk segments. This is advantageous particularly for the coating of the disk segments with wear-resistant material, which is necessary from time to time, since the hub is rapidly detachable from the disk segments.

In a refinement according to the present invention, the milling disk has openings. The milling effect is elevated by these openings. In addition, the disk segments may be connected to one another using screws which are directed from one opening to another.

The stability of the disk made from multiple disk segments may and/or must be elevated depending on the size of the diameter of the milling disk. For this purpose, the locations of the joints of the disk segments may be designed differently, the variations extending from a mere butted joint via projections and recesses up to tongue and groove designs.

### BRIEF DESCRIPTION OF THE DRAWINGS

In the following, the present invention is described in greater detail on the basis of exemplary embodiments:

FIG. 1 shows a schematic illustration of a disk-shaped milling element having five disk segments;

FIG. 2 shows a partial section of the disk shown in FIG. 1;

FIG. 3 shows a schematic illustration of a disk-shaped milling element having five disk segments, each having a double screw connection;

FIG. 4 shows a partial section of the milling disk shown in FIG. 3;

FIG. 5 shows a schematic illustration of a disk-shaped milling element, made of two segments;

FIG. 6 shows a partial section of the milling disk shown in FIG. 5;

FIG. 7 shows a schematic illustration of a disk-shaped milling disk having a special hub attachment; and

FIG. 8 shows a partial section of the milling disk shown in FIG. 7.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF PREFERRED EMBODIMENTS

FIG. 1 shows a milling element 12, including five disk segments 14, 16, 18, 20, 22. The disk segments have a disk core 24, which is enclosed by a plastic or rubber coating 26. The disk segments are provided on their legs 28, 30, as also shown in FIG. 2, with projections 32 and recesses 34, which ensure the axial support of the disk transitions. To elevate the milling and mixing performance which the milling elements transfer to the milled product/milling body mixture, the disk segments 14, 16, 18, 20, 22 have oblong openings 36. The five disk segments 14 through 22 and the centrally positioned one-piece hub are connected to one another by screws 40. The form fit between the drive shaft and the hub 32 arises through the insertion of a spring into the groove 42.

Depending on how the transition of the disk segments 14, 16, 18, 20, 22 is designed, in a butted embodiment in the example shown in FIG. 2, the attachment changes between the disk segments 14, 16, 18, 20, 22 and the hub. To elevate the stability, the disk segments are clamped to the hub 38 using a double connection by screws 40, 40′, as shown in FIG. 3.

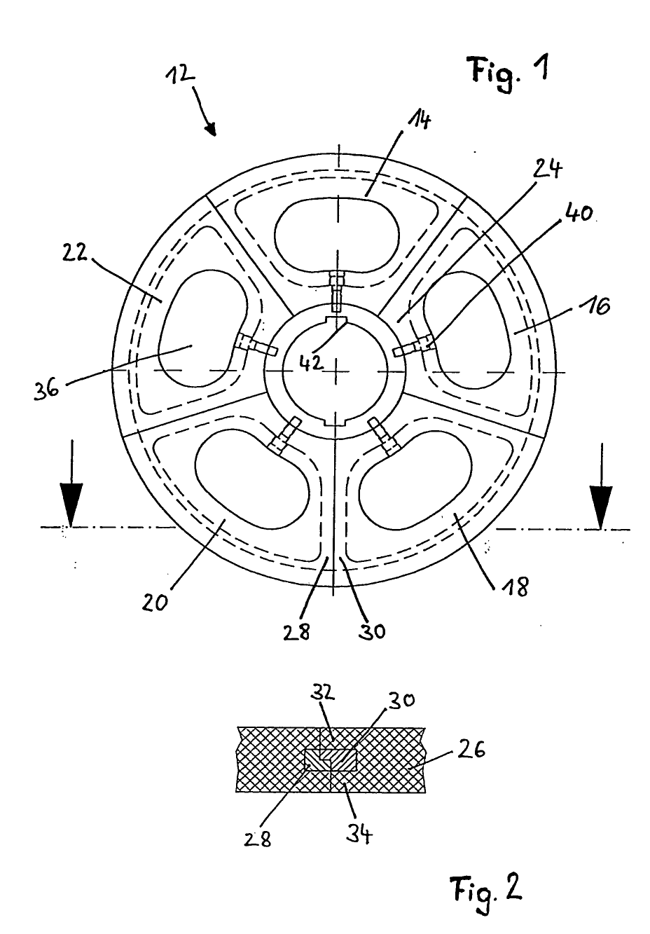

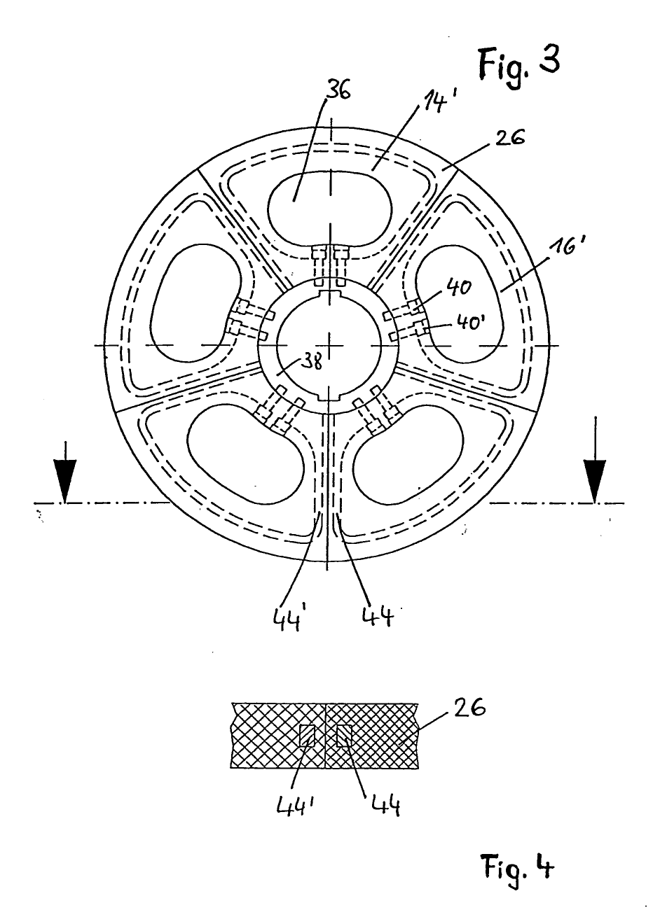

A web 44, 44′ having an appropriate plastic or rubber coating 26 may be seen in the partial section of a pair of the disk segments 18′, 20′ shown in FIG. 4.

In all exemplary embodiments up to this point, the disk segments 14 through 22 of the milling elements may be removed or replaced individually, but the hub 38 itself is in one piece and encloses the agitating shaft. Therefore, the hub and/or the hubs 38 may only be removed by removing one or more hubs 38 or spacer bushings possibly positioned between the hubs from the agitating shaft.

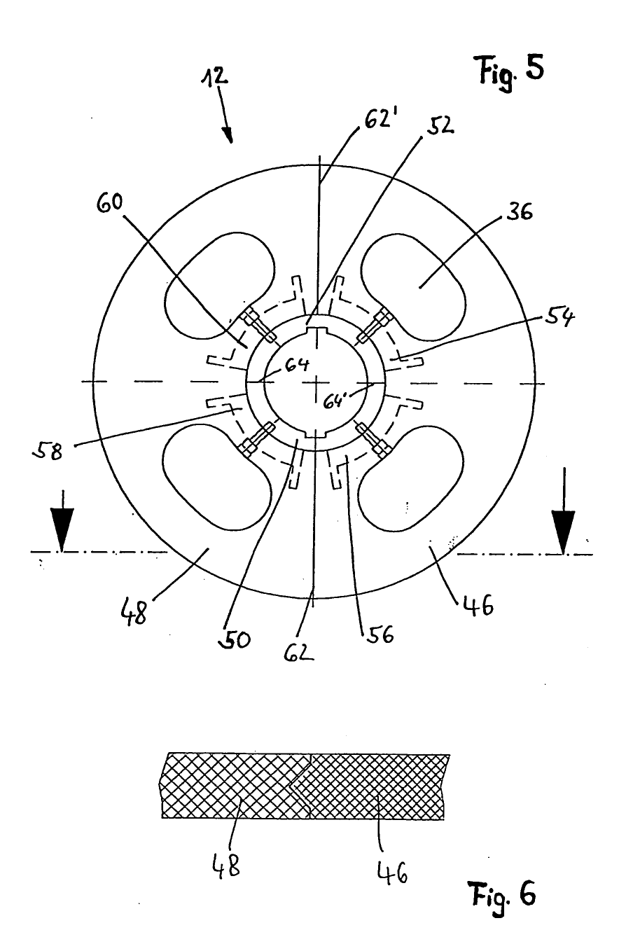

FIG. 5 shows a milling element 12 which may be assembled from both two disk segments 46, 48 and two hub elements 50, 52. Metal reinforcements 54, 56, 50, 60 are introduced into the disk elements 46, 48, which are manufactured from plastic (polyamide, polyurethane). These metal reinforcements 54, 56, 58, 60 are connected to the hub using screws. Each disk segment 46, 48 is offset by 90°, for example, to the partition line 64, 64′ of the hub elements 50, 52.

FIG. 6 illustrates the design of the legs of the disk segments 46, 48 shown in FIG. 5. The swallowtail connection shown, which both disk segments 46, 48 enter into in the region of their legs, elevates their stabilization in addition to the attachment by the screws.

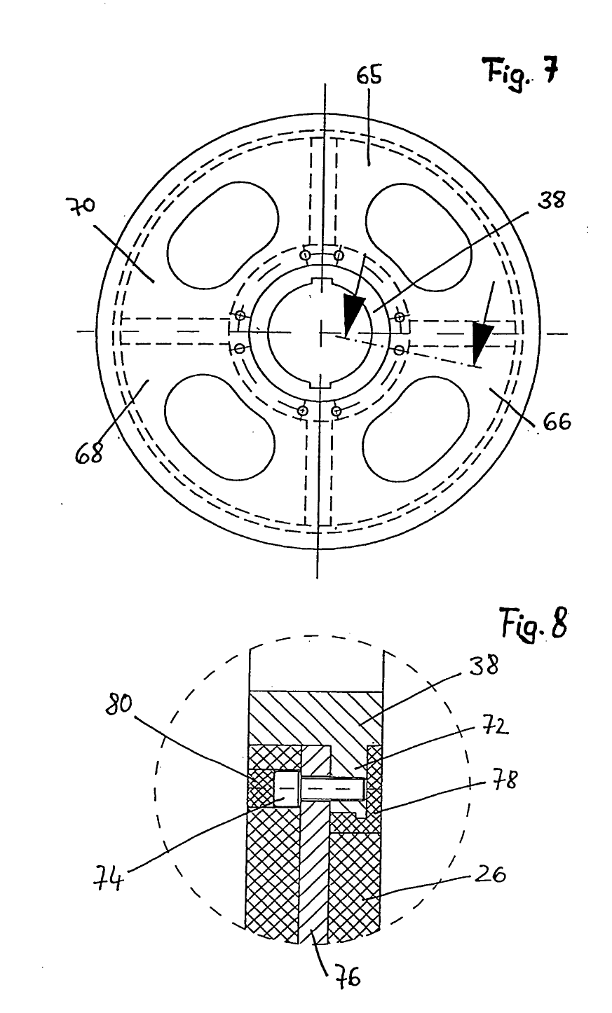

A further possibility for connecting the disk segments 65, 66, 68, 70 to the hub 38 is shown in FIG. 7 and FIG. 8. In this case, the disk segments are attached in the inner radius region in the direction of their axis of rotation A to a web projecting outward from the hub 38. Each of the four disk segments 65, 66, 68, 70 has two screw connections in this overlap region of web 72 and disk segment 65, 66, 68, 70. The screws 74 used for this purpose penetrate the core 76 of the disk segments 65, 66, 68, 70 and are screwed together with the thread in the web 72 in this case. The coating 26, which is left out in this region, is supplemented here through individual covers 70, 88 made of plastic or rubber, so that the surface of the disk segments subjected to higher wear is provided with a complete coating.

According to a further variation of the present invention, direct connection of two or more disk segments is provided. In these exemplary embodiments, the disk segments are screwed directly to one another and among one another. In this case, screws extend from the openings up into the neighboring disk segment. Alternatively, pin connections in the region of the shaft or clamped connections between the projections on the disk segments may ensure the solid connection. In this type of connection, no central hub is provided in the center of the disk elements.

Further modifications and alternative embodiments of various aspects of the invention will be apparent to those skilled in the art in view of this description. It is, therefore, intended that the following claims be interpreted to embrace all such modifications and changes. In addition, the specification and drawings are to be regarded in an illustrative rather than a restrictive sense.

1. An agitating mill comprising a milling container and an agitating shaft rotating therein, on which multiple disk-shaped milling elements (12) are positioned in a row, wherein the annular disk of a disk-shaped milling element (12) is assembled from multiple disk segments (14, 16, 18, 20, 22, 46, 48, 65, 66, 68, 70), through which replacement of individual milling elements without dismantling further milling elements from the agitating shaft is made possible.

2. The agitating mill according to claim 1, wherein the disk segments (14, 16, 18, 20, 22, 46, 48, 65, 66, 68, 70) are connected to a hub (38).

3. The agitating mill according to claim 2, wherein the hub (38) is multipart and is connected via detachable connections to the disk segments (14, 16, 18, 20, 22, 46, 48, 65, 66, 68, 70).

4. The agitating mill according to claim 1, wherein the annular disk includes two to five disk segments (14, 16, 18, 20, 22, 46, 48, 65, 66, 68, 70) which may be clamped to one another.

5. The agitating mill according to claim 1, wherein the disk segments (14, 16, 18, 20, 22, 46, 48, 65, 66, 68, 70) are supported on the neighboring disk segments on each of their legs via a projection and recess (32, 34).

6. The agitating mill according to claim 2, wherein the disk segments (14, 16, 18, 20, 22, 46, 48, 65, 66, 68, 70) are provided with a plastic or rubber coating (26).

7. The agitating mill according to claim 6, wherein the coated disk segments (14, 16, 18, 20, 22, 46, 48, 65, 66, 68, 70) are connected to the hub (38) through detachable connection elements and the legs (28, 30) of the disk elements abut one another.

8. The agitating mill according to claim 1, wherein the annular disk includes two disk segments which have tongue and groove connections on their legs.

9. The agitating mill according to claim 2, wherein the disk segments (14, 16, 18, 20, 22, 46, 48, 65, 66, 68, 70) are connected to the hub (38) via screw connections which extend from the region of the openings (36) up into the region of the hub (38).

10. The agitating mill according to claim 2, wherein at least one partition line (62, 62′) between the disk segments (14, 16, 18, 20, 22, 46, 48, 65, 66, 68, 70) is offset to at least one partition line (64, 64′) of segments of the hub by an angle of 15°-90°.

11. The agitating mill according to claim 2, wherein the hub (38) has a radial shoulder (72) to which the disk segments (65, 66, 68, 70) are attached.

12. The agitating mill according to claim 2, wherein the disk segments (14, 16, 18, 20, 22, 46, 48, 65, 66, 68, 70) are connected to the hub segments by screw connections which run parallel to the axis of rotation (A) or radially.

13. The agitating mill according to claim 12, wherein both the front and/or the back of the disk segments (14, 16, 18, 20, 22, 46, 48, 65, 66, 68, 70) are provided in the region of the screw connections with covers (78, 80) which may be placed later.

14. The agitating mill according to claim 1, wherein the disk segments (14, 16, 18, 20, 22, 46, 48, 65, 66, 68, 70) are connected directly to one another via pin or screw or clamp devices, without a hub being present.

15. The agitating mill according to claim 1, wherein the disk segments (14, 16, 18, 20, 22, 46, 48, 65, 66, 68, 70) are provided with openings (30).
